(19) United States
(12) Patent Application Publication
(10) Pub. No.: US 2019/0103635 A1
(43) Pub. Date: Apr. 4, 2019

(54) PILE A CATHODE LIQUIDE HYBRIDE

(71) Applicant: COMMISSARIAT À L'ÉNERGIE ATOMIQUE ET AUX ÉNERGIES ALTERNATIVES, Paris (FR)

(72) Inventors: Eric Mayousse, Meylan (FR); Lionel Blanc, Fontaine (FR); Benoît Chavillon, Grenoble (FR)

(21) Appl. No.: 16/145,794

(22) Filed: Sep. 28, 2018

(30) Foreign Application Priority Data
Sep. 29, 2017 (FR) 17 59133

(51) Int. Cl. H01M 10/0569; H01M 10/39; H01M 4/36; H01M 10/0567; H01M 10/0563; H01M 4/66

(52) U.S. Cl. CPC H01M 10/0569; H01M 10/39; H01M 4/663; H01M 10/0567; H01M 10/0563; H01M 4/366

(57) ABSTRACT

A liquid cathode cell comprising: a calcium anode; an electrolyte comprising a sulfur and/or phosphorus oxidizing solvent and at least one salt; a cathode comprising a compound identical to the aforementioned oxidizing solvent as active material; characterized in that the cathode comprises a first zone consisting of a carbon matrix comprising entwined carbon fibers having a porosity of at least 90% and a specific surface area less than or equal to 5 m2/g, and comprising a second zone that is distinct from the first zone, wherein the second zone consists of a composite material comprising a binder and carbon black.

### TECHNICAL AREA

The present invention relates to a specific liquid cathode cell and, more specifically, to a liquid cathode and calcium anode cell having a cathode matrix of the hybrid type that allows the use of these cells both at low temperature (for example, from −40° C.) and at high temperature, for example, at temperatures above 150° C., without generating safety problems and that also allows delivery of a voltage from room temperature.

The present invention may find application in all fields requiring the production of electrical energy, especially in contexts where the temperature is particularly high, as in the case of petroleum applications such as in the field of drilling or monitoring wells in production, or in the field of geothermal energy.

As mentioned above, the cells of the invention are based on liquid cathode cell technology, which means, in other words, that they rely on the particularity that the active compound used at the cathode is a compound liquid, which, moreover, also serves as the solvent of the electrolyte, wherein the liquid compound conventionally impregnates a cathode matrix.

One of the leading models of this type of cell is the lithium-thionyl chloride cell, which typically consists of the following elements:
a negative electrode (or anode) made of lithium metal, in which the oxidation of lithium occurs according to the following reaction:

Li→Li⁺e⁻
a positive electrode (or cathode) generally comprising a matrix capable of trapping the liquid active compound, thionyl chloride in this case, which is reduced according to the following reaction:

2SOCl₂+4e⁻→5+SO₂+4Cl⁻
an electrolyte arranged between the negative electrode and the positive electrode, wherein the electrolyte comprises as the solvent, thionyl chloride, salts and optionally one or more additives,
the negative electrode and the positive electrode are connected to an external circuit, which receives the electric current produced via the aforementioned electrodes.

By combining the electrochemical reaction at the positive electrode and the electrochemical reaction at the negative electrode, the global reaction (called discharge) may be represented by the following equation:

4Li+2SOCl₂→S+SO₂ (partially dissolved)+4 LiCl (precipitated)

wherein the products of the reaction are thus sulfur, partially soluble in the electrolyte, SO₂ gas, which partially solubilizes in the electrolyte, and a lithium chloride salt LiCl, which precipitates to form a continuous network in the constituent carbon matrix of the positive electrode. Since lithium chloride is a crystalline material, it progressively reorganizes in the matrix in order to occupy the empty space, wherein the matrix thus constitutes a zone for recovering the reaction products.

The carbon matrix may take one of the following forms:
a matrix resulting from a compressed powder, for example a graphite powder and having a large specific surface, as defined in FR 2 166 015;
a carbon matrix, for example, acetylene black comprising a dispersion of copper particles, wherein the carbon matrix results from the agglomeration of powders, as described in FR 2 402 307;
a carbon matrix composed of a carbon aerogel with a high specific surface area, as described in FR 2 872 347.

While, from the point of view of their electrochemical characteristics, the Li/SOCl₂ cells offer a certain number of advantages (for example, a thermodynamic voltage of 3.64 V per cell based on the variation of free enthalpy due to the above-mentioned global discharge reaction, a high theoretical mass energy of 1470 Wh/kg (of the order of 5273 kJ/kg), a very low self-discharge phenomenon (estimated at 1% loss of capacity per year at a temperature of 20° C.), an operating temperature ranging from −60° C. (limitation imposed by the electrolyte) to 180° C. (limitation imposed by lithium metal), a low internal pressure, because the gaseous reaction products, such as SO₂, are partly soluble in the electrolyte), this system also has a certain number of drawbacks, in particular because of the reactivity of metallic lithium with the humidity of the air or of water, to form hydrogen and lithium LiOH with the production of heat. In addition, a passivation layer is formed on the surface of the lithium (this layer comprises LiCl), which may cause a voltage drop during a current draw.

Finally, as suggested above, the use of this system is theoretically limited to a temperature of 180° C., the melting point of lithium beyond which short circuits occur generating a thermal runaway and overpressure of the cell, which may lead to its destruction.

Also, at temperatures above 180° C., the use of such cells is no longer possible because of the melting of the lithium. In addition, the use of lithium anode cells poses safety problems arising during their production, transportation, use, or even recycling.

To overcome these drawbacks, it has been proposed to use, as constituent material of the negative electrode, a material based on a lithium alloy with a second metal which has a melting point higher than that of lithium metal alone, wherein an alloy of this type would be an alloy of lithium and magnesium, as described, in particular, in U.S. Pat. No. 5,705,293, and more specifically, alloys comprising a magnesium proportion of 30%, which makes it possible to access operating temperatures of 200-220° C. In fact, the introduction of magnesium in this proportion induces a shift towards higher values of melting temperature, as evidenced by the Li/Mg phase diagram.

However, given the strong internal resistance of these cells comprising such an alloy at the negative electrode, it is necessary to condition them before use, wherein these conditioning operations may be restrictive for the user. On the other hand, these cells may also present safety problems in the event of melting temperature of the anode being exceeded.

As an alternative, cells safer than lithium cells have also been proposed, wherein these cells operate with an anode that is no longer lithium but calcium, and a cathode based on thionyl chloride, wherein this type of cell is called a Ca/thionyl chloride cell.

This type of cell conventionally comprises the following elements:
a negative electrode (or anode) of metallic calcium, wherein the oxidation of calcium occurs according to the following reaction:

Ca→Ca²⁺+2e⁻
a positive electrode (or cathode) also comprising a matrix capable of trapping the liquid active compound, in this case thionyl chloride, which is reduced according to the following reaction:

2SOCl₂+4e−→S+SO₂+4Cl⁻
an electrolyte arranged between the negative electrode and the positive electrode,

wherein the global reaction (called discharge) is schematized by the following equation:

2Ca+2SOCl₂→2CaCl₂+SO₂+S

The sulfur and sulfur dioxide are, in whole or in part, soluble in the electrolyte, while calcium chloride CaCl₂ will also precipitate in the matrix with, however, the different behavior of lithium chloride LiCl.

In fact, since a calcium atom has a size of 180 μm (compared to 145 μm for lithium) and, when it is chlorinated, a calcium atom binds to two chlorine atoms instead of just one atom for a lithium atom, calcium chloride molecules CaCl₂ are larger than lithium chloride molecules. Moreover, calcium chloride CaCl₂ is an amorphous solid, unlike lithium chloride LiCl which is crystalline.

Thus, during the deposition of calcium chloride on the matrix, there is no reorganization thereof within the matrix due to its amorphous and non-conductive electronic nature. Moreover, because of its larger volume, it may cause:
deposition only on the surface of the matrix (and not in its pores), which may cause strong resistance to the discharge reaction of the cell and eventually cause it to stop;
or, if the deposition takes place in the pores of the matrix, it may cause clogging of the latter that may prevent the catholyte from circulating, or that may even cause the imprisonment of a portion of the catholyte within the matrix thus making it unavailable for subsequent reactions.

On the other hand, calcium allows operation at higher temperatures than with lithium, wherein these higher temperatures contribute to the exacerbation of the aforementioned phenomena. In addition, a matrix working properly at room temperature could see its yield greatly reduced at the high temperatures practicable with calcium, because it would no longer have a network of pores with an input diameter or volume that would be sufficient to accommodate CaCl₂ molecules resulting from the reactions of the cell.

Moreover, if the start of a cell discharge occurs at room temperature, there is a problem at these low temperatures with respect to the discharge voltage, which is extremely low and not of interest for most applications.

In view of what exists, the authors of the present invention have set themselves the objective of setting up a new type of liquid cathode and calcium anode cell, and, more specifically, a liquid cathode cell allowing efficient operation in terms of voltage delivered (especially greater than 2.5 V) at low temperatures (for example, from −40° C.) to high temperatures (for example, above 200° C.).

### DESCRIPTION OF THE INVENTION

The invention also relates to a liquid cathode cell comprising:
a calcium anode;
an electrolyte comprising a sulfur and/or phosphorus oxidizing solvent and at least one salt;
a cathode comprising a compound identical to the aforementioned oxidizing solvent as active material;

characterized in that the cathode comprises a first zone consisting of a matrix comprising entwined carbon fibers having a porosity of at least 90% and a specific surface area less than or equal to 5 m²/g, and comprising a second zone that is distinct from the first zone, wherein the second zone consists of a composite material comprising a binder and carbon black.

Thus, the cells of the invention comprise a cathode of hybrid structure, which is able to operate efficiently at high temperatures due to the presence of the first zone, and also at low temperatures due to the presence of the second zone. In other words, thanks to this cathode, the cells of the invention are able to operate efficiently over a wide range of temperatures, for example, from −40° C. to 300° C.

Before going into more detail in the description of the invention, the following definitions are specified.

By cathode is conventionally meant, in the foregoing and in what follows, the electrode which is the site of a reduction reaction, i.e. the reduction of the liquid active material in this case, when the cell delivers current, i.e. when it is in the process of discharge. The cathode may also be described as the positive electrode.

By anode is conventionally meant, in the foregoing and in what follows, the electrode which is the site of an oxidation reaction, when the cell delivers current, i.e. when it is in the discharge process. The anode may also be described as a negative electrode.

By active material is conventionally meant, in the foregoing and in what follows, the material which is directly involved in the reduction reaction taking place at the cathode, wherein the active material in the context of the invention is an active liquid material of the same nature as the sulfur and/or phosphorus oxidizing solvent constituting the electrolyte.

As indicated above, the cathode of the cells according to the invention comprises, as the first zone, a specific carbon matrix, which makes it possible to receive the active material and also to recover the reaction products of the cell such as CaCl₂.

This carbon matrix comprises entwined carbon fibers, and, even more specifically, in fact comprises, mainly or exclusively, entwined carbon fibers. These carbon fibers may advantageously have a length of less than 20 mm and a diameter of less than 15 μm. Specifically, the carbon matrix may be in the form of a web of carbon fibers.

In addition, the carbon matrix has a porosity of at least 90%, preferably greater than or equal to 92%, for example from 92% to 98%, or greater than 95%, and the carbon matrix has a specific surface area of less than or equal to 5 m²/g, for example from 0.5 to 5 m²/g, or even less than 1 m²/g.

It is specified that the porosity corresponds to the void volume of the matrix relative to its total volume. To measure the porosity, the matrix, whose amount and geometric characteristics (length, width and thickness) are known, is placed in an initial given volume of electrolyte. Then the difference between the electrolyte volume after immersion of the matrix and the initial volume of electrolyte is measured, and this difference corresponds to the void volume of the matrix. The porosity is deduced by determining the ratio of the void volume with respect to the total volume of the matrix.

It is specified that the specific surface area is measured by the BET method implemented using a Micromeritics Tristar II Surface Area and Porosity apparatus, wherein this method is described in the Journal of the American Chemical Society, p. 309 (60), 1938.

By combining a high porosity with a low specific surface area, it is thus possible to overcome the drawbacks mentioned above, namely the deposition of CaCl₂ on the surface of the matrix and in the porosity, which may cause clogging of the latter, and to ensure longer cell life for low medium and high temperature operation.

Finally, the carbon matrix may also meet one or more of the following characteristics:
a grammage less than or equal to 20 g/m²;
a thickness of less than 1 mm, preferably less than 0.5 mm when the matrix is in the form of a plate;
the carbon matrix is devoid of binder, such as polymeric binder such as polytetrafluoroethylene in order to ensure mechanical strength.

Regarding the grammage, it is determined by the measurement of the weight of matrix, wherein the value of the weight relates to the surface area in m² of the matrix. Since this grammage is advantageously less than or equal to 20 g/m², this induces an increase in the weight of the matrix and therefore of the electrochemical system into which the matrix is introduced, and, consequently, an increase in the mass energy density of the system.

Finally, this carbon matrix is advantageously self-supporting. By a self-supporting matrix is meant a matrix that supports itself, in other words, that does not need to be affixed to a support, for example, a grid or metal strip, to ensure its mechanical strength.

In addition, for the recovery of the current, the matrix may be provided with one or more metal parts, for example, in the form of tabs (such as nickel metal parts) attached to one of the faces of the matrix by simple welding.

The cathode also includes a second zone that is distinct from the first zone, wherein the second zone consists of a composite material comprising a binder and carbon black.

As regards the carbon black, it may be, in particular, acetylene black, which corresponds to a carbon black obtained by cracking acetylene at very high temperatures (for example, temperatures of more than 2000° C.), and has the advantage of having a marked conductive character.

As regards the binder, it may be a polymeric binder which forms a matrix for the carbon black (which thus constitutes a filler) and, more specifically, it may be a polymeric binder belonging to the category of fluorinated ethylenic polymeric binders, such as polytetrafluoroethylene (known by the abbreviation PTFE), polyvinylidene fluoride (known by the abbreviation PVDF) and/or fluorinated ethylenic copolymers (such as copolymers of vinylidene fluoride and hexafluoropropylene).

This binder may represent from 3 to 30% by weight relative to the total weight of the composite material.

This second zone may be deposited on a current collector, wherein the latter consists, for example, of a strip or a metal grid, which may have a thickness ranging from 10 to 500 μm. In this case, this second zone may be deposited only on a part of one of the faces of the current collector.

For example, this second zone may be in the form of one or more layers having a thickness ranging from 0.5 to 5 mm, preferably from 0.5 to 2 mm, in particular in the case of a cell having a C shape. When the second zone consists of several layers, they may be in the form of separate layers deposited on a current collector (for example, in the form of parallel strips pasted on one of the faces of a current collector occurring, for example, in the form of a grid).

The first zone and the second zone are advantageously in contact with one another.

For example, according to a first embodiment, when the second zone consists of a second zone deposited on a current collector, the contact between the first zone and the second zone may be established via the face of the current collector on which is deposited the second zone.

FIGS. 1 to 3 illustrate views of a hybrid positive electrode used in the constitution of a cell according to the invention, wherein FIG. 1 shows an exploded view of the positive electrode, while FIGS. 2 and 3 respectively show a front and rear view of the assembled positive electrode.

The positive electrode thus represented comprises respectively:
a first zone 1 consisting of a web of carbon fibers meeting the specific features of the invention and having a parallelepipedal shape, wherein the first zone has, before assembly, holes 5, which allow, on the one hand, the connection with the second underlying zone through welding, and, on the other hand, the connection with current collectors through welding (after assembly, the holes are thus filled with a welding material);
current collectors in the form of tabs 6 or current recovery metal tabs (for example, made of nickel and having a thickness of 5 mm) and welded to the first zone via the holes 5, wherein the tabs are arranged perpendicularly to the first zone and parallel to each other with a spacing of between 20 and 50 mm;
a second zone 7 formed of layers 9 of a composite material comprising a binder and carbon black pasted on a grid 11 to form a current collector (the grid may be an expanded nickel grid).

The first zone is thus maintained between the supporting grid of the second zone and the current collectors in the form of tabs.

Other hybrid positive electrode configurations are shown in FIGS. 6 and 7.

More specifically, FIG. 6 shows the positive electrode respectively comprising:
a first zone 25 consisting of a web of carbon fibers meeting the specific features of the invention and having a parallelepipedal shape, wherein the first zone has, before assembly, holes 27, which allow, for some of them, connection with two current collectors through welding, and, for the others, connection with the second underlying zone through welding (the holes are thus, after assembly, filled with a welding material);
current collectors in the form of two tabs 29 that are welded to the first zone via some of the holes 27, wherein the tabs are arranged perpendicularly to the first zone and parallel to each other with a spacing of between 20 and 50 mm;
a second zone 31 formed by a layer 33 of a composite material comprising a binder and carbon black pasted on a grid 35 forming a current collector (the grid may be an expanded nickel grid), wherein the layer leaves unoccupied areas 35 at the corners of the grid, on its periphery and in its central part.

In FIG. 7, the positive electrode thus represented comprises respectively:
a first zone 37 consisting of a web of carbon fibers meeting the specific features of the invention and having a parallelepipedal shape, wherein the first zone has, before assembly, holes 39 (4 in total), which, on the one hand, allows connection with the second underlying zone through welding, and, on the other hand, connection with current collectors through welding (the holes are thus, after assembly, filled with a welding material);
two current collectors in the form of two tabs 41 welded to the first zone via the holes 39, wherein the tabs are arranged perpendicularly to the first zone and parallel to each other;
a second zone 43 in the form of three layers of a composite material comprising a binder and carbon black pasted on a grid 45 forming a current collector (the grid may be an expanded nickel grid), wherein two layers are located at two ends of the grid, while the last layer is located on the middle part of the grid.

According to a second embodiment, the contact may be established by the composite material constituting the second zone being directly deposited on a part of the surface of the first zone. In this case, the second zone may have a surface corresponding to a value of 10 to 50% of the area of the first zone.

The anode may be, in turn, a calcium anode (i.e. an anode exclusively composed of calcium). Calcium has the advantage of having a high melting point (of the order of 842° C.). In addition, calcium has a volume capacity of 2.06 Ah/cm³ that is equal to that of lithium. This allows the same calcium capacity in a cell for equal volume.

As mentioned above, the electrolyte comprises a sulfur and/or phosphorus oxidizing solvent and at least one salt, wherein this sulfur and/or phosphorus oxidizing solvent also constitutes the active material of the cathode.

More specifically, the oxidizing solvent may be:
a sulfur-containing solvent comprising one or more chlorine atoms, such as a solvent selected from thionyl chloride (SOCl₂), sulfuryl chloride (SO₂Cl₂), disulfur dichloride (S₂Cl₂), sulfur dichloride (SCl₂);
a non-chlorinated sulfur solvent, such as sulfur dioxide (SO₂); or
a phosphorus and, optionally, sulfur-containing solvent comprising one or more chlorine atoms, such as phosphoryl trichloride (POCl₃) or thiophosphoryl trichloride (PSCl₃).

Preferably, the oxidizing solvent is thionyl chloride (SOCl₂).

The salt present in the electrolyte may result from the reaction of a Lewis acid and a Lewis base, wherein this reaction may take place ex situ, i.e. before introduction into the cell or in situ, i.e. within the cell, when the Lewis acid and the Lewis base are introduced into the cell.

More specifically, the salt may be produced by reaction:
of a Lewis base of formula A¹X₂, wherein X represents a halogen atom, such as a chlorine atom, a bromine atom, a fluorine atom, an iodine atom, and wherein A¹ represents a divalent element, such as an alkaline earth element such as Ca and Sr, of formula A²X, wherein X is as defined above and A² represents a monovalent element, such as an alkaline element such as Na, Li or an ammonium group NH₄⁺, of formula A³X₃, wherein X is as defined above and A³ represents a trivalent element such as Ba; and
of a Lewis acid chosen from an aluminum halide ALX₃, a gallium halide GaX₃, a boron halide BX₃, an indium halide InX₃, a vanadium halide VX₃, a silicon halide SiX₄, a halogenide of niobium NbX₅, a tantalum halide TaX₅, a tungsten halide WX₅, a bismuth halide BiX₃, borohydrides, chloroborates and mixtures thereof, wherein X represents, as above, a halogen atom such as a bromine atom, a chlorine atom, a fluorine atom and an iodine atom.

Preferably, the Lewis acid is (AlCl₃) or (GaCl₃) and the Lewis base is SrCl₂, especially when the oxidizing solvent used is thienyl chloride.

In addition to the presence of a solvent and a salt as defined above, the electrolyte may comprise one or more additives chosen, for example, to limit the self-discharge and discharge corrosion of cells.

The additives may be selected from hydrofluoric acid HF, SO₂, salts such as GaCl₃, BiCl₃, BCl₃, GaCl₃, InCl₃, VCl₃, SiCl₄, NbCl₃, TaCl₅, PCl₅ and WCl₆.

The additives may be present in an amount ranging from 0 to 50% of the salt concentration.

The cells of the invention may be developed according to different technologies and, in particular, according to two cylindrical cell technologies, which are so-called coaxial electrode structure cells and so-called spiral electrode structure cells, wherein these cells may have different formats (such as AAA, AA, C, D or DD formats).

For the cells of the so-called spiral electrode structure, they conventionally comprise, two rectangular flat electrodes whose width must be compatible with the height of the well and having a length that is so configured that, when wound on themselves, they constitute a cylinder whose diameter allows its introduction into the well to accommodate these electrodes.

With respect to cells of so-called coaxial electrode structure, it may be, in particular, a cell for which the cathode forms an envelope around the anode, wherein the envelope consisting of the cathode is not in contact with the anode but is separated from it by an inter-electrode gap comprising the electrolyte. Even more specifically, the anode may be advantageously in the form of a calcium cylinder, wherein the cylinder is, advantageously, a solid cylinder, while the cathode, which is arranged around the anode, is advantageously in the form of a cylindrical envelope advantageously having the same axis of revolution as the calcium cylinder, wherein it is to be understood that the calcium cylinder and the cylindrical envelope constituting the cathode are not in contact with one another, but are separated by an inter-electrode gap comprising the electrolyte. An example of such a configuration is shown in FIG. 5 and specifically described in Example 1 below.

As mentioned above, the cells of the invention find their application in all areas requiring the production of electrical energy in a wide temperature range as a result of the hybrid structure of the cathode and, in particular, in contexts where the temperature is high (especially temperatures above 200° C.), which is particularly the case, in oil exploration and exploitation or in drilling for the use of geothermal energy. In these fields, the cells of the invention may thus be used for the electrical power supply of measurement systems, which already include electronic components allowing operation at such temperatures.

The invention will now be described with reference to the particular embodiments defined below and with reference to the appended figures.

### BRIEF DESCRIPTION OF THE FIGURES

FIGS. 1 to 3 show views of a hybrid positive electrode capable of entering the constitution of a cell according to the invention.

FIG. 4 shows a view of a hybrid positive electrode forming part of a cell of cylindrical geometry in accordance with the invention and illustrated in example 1.

FIG. 5 shows a sectional view of a cell according to the invention and defined in example 1.

FIGS. 6 and 7 show views of a hybrid positive electrode that may enter into the constitution of a cell according to the invention.

FIG. 8 shows a curve illustrating the evolution of the cell voltage U (in V) as a function of time (in s) at constant current (20 mA) and at 20° C. (respectively a solid curve for the cell according to the invention and a dashed curve for the cell not according to the invention).

FIG. 9 shows a curve illustrating the evolution of the cell voltage U (in mV) as a function of time (in h) at constant current (10 mA) and at 20° C. (respectively a solid curve for the cell not according to the invention and a dashed curve for the cell according to the invention).

FIG. 10 shows a curve illustrating the evolution of the cell voltage U (in mV) as a function of the time t (in h) at constant current (10 mA) and at 220° C. (respectively a solid curve for the cell according to the invention and a dashed curve for the cell not according to the invention).

FIG. 11 shows a curve illustrating the evolution of the cell voltage U (in mV) as a function of the charge Q (in mAh) for experiments in example 4.

FIG. 12 shows a curve illustrating the evolution of the cell voltage U (in mV) as a function of the charge Q (in mAh) for experiments in example 4.

FIG. 13 shows a curve illustrating the evolution of the cell voltage U (in mV) as a function of the charge Q (in mAh) for experiments in example 4.

### DETAILED PRESENTATION OF PARTICULAR EMBODIMENTS

### Example 1

The purpose of this example is to demonstrate the performance of a cell according to the invention in terms of discharge at room temperature (20° C.) in comparison with a cell not according to the invention.

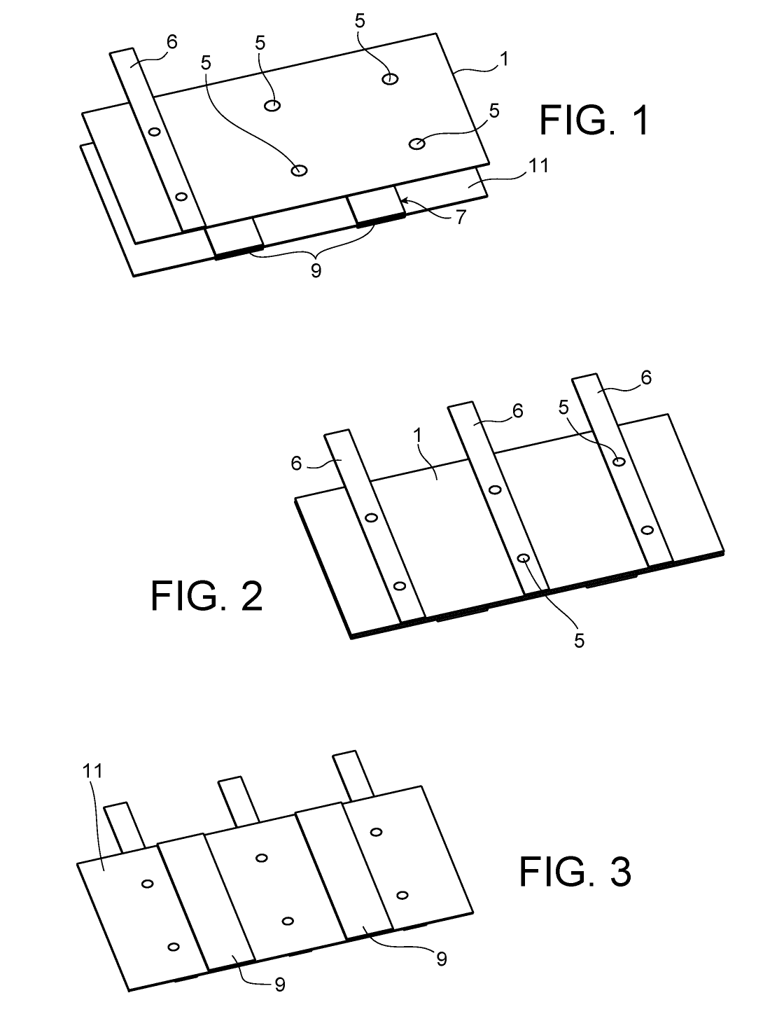

For the cell according to the invention, the positive electrode used is that shown in FIG. 1 before assembly in a cell, wherein this electrode comprises the following elements:
a first zone 1 constituted by a web of carbon fibers having a porosity of 95%, a thickness of 200 μm, a specific surface area of 2.5 m²/g and having a parallelepipedal shape, wherein the first zone has, before assembly with the second zone, holes 5, which allow, on the one hand, connection with the second underlying zone through welding and, on the other hand, connection with current collectors through welding (after assembly, the holes are thus filled with solder material);
three current collectors in the form of tabs 6 made of nickel and having a width of 5 mm and a length of 45 mm and welded to the first zone via the holes 5, wherein the tabs are arranged perpendicularly to the first zone and parallel to each other with a spacing of 15 mm;
a second zone 7 formed by layers 9 in the form of two strips 7 mm wide of a composite material (comprising 25% by weight of polyvinylidene fluoride (Teflon®), 37.5% by weight of acetylene black Y50A and 37.5% by weight of acetylene black YS) pasted on an expanded nickel grid 11 forming a current collector that is 300 μm thick.

The first zone is thus maintained between the supporting grid of the second zone and the electrical connection tabs.

The above-mentioned second zone is made by initially covering the expanded nickel grid with the aforementioned composite material and then scraping the material in order to leave only the layers 9 (which corresponds to a scraping of 70% of the surface initially covered).

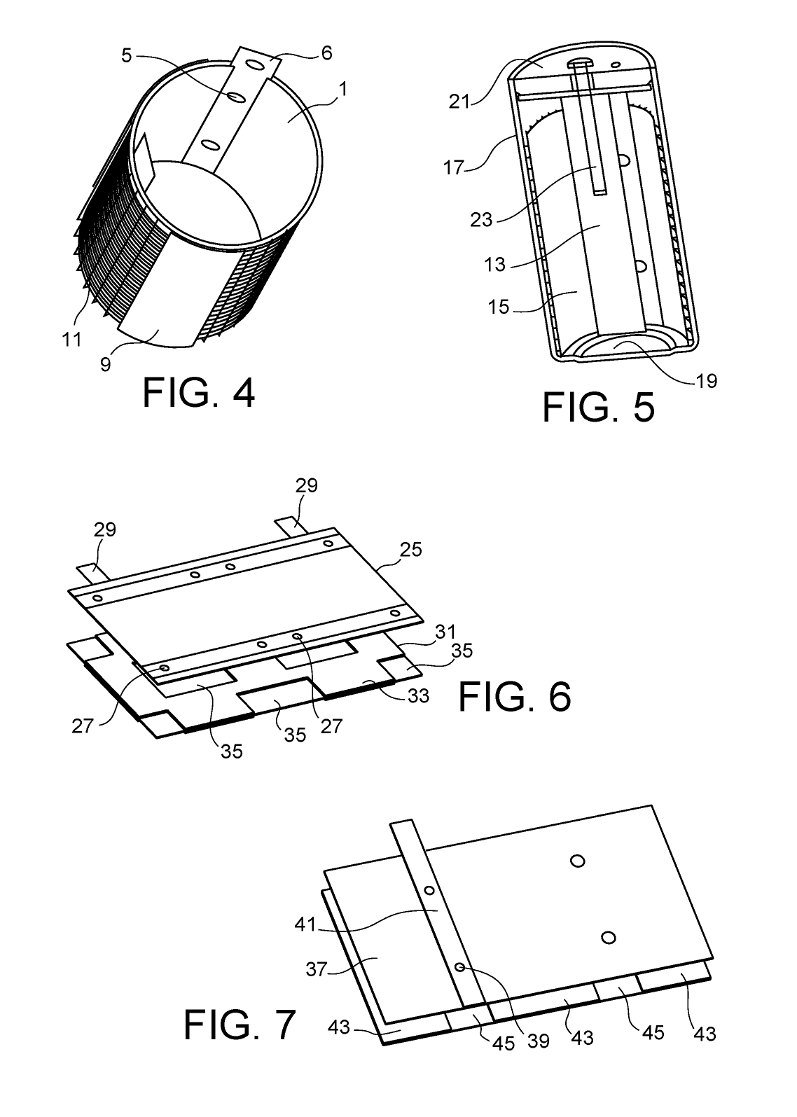

Just before incorporation into a so-called coaxial electrode structure cell (C format), the two ends of the positive electrode are placed end to end and in contact with each other in order to form a cylinder (40 mm high, 20 mm in diameter) as shown in FIG. 4, wherein the reference numerals in this figure are identical to those of FIGS. 1 to 3, insofar as they designate the same elements.

The cell according to the invention and illustrated in FIG. 5 more specifically comprises the following elements:
a negative electrode 13 or a solid cylindrical anode placed in the center of the cell and having a height of 42 mm and a diameter of 9 mm;
a cylindrical positive electrode 15 defined above forming an envelope around the anode without contact with it;
between the positive electrode and the negative electrode, an inter-electrode space comprising an electrolyte (1.5 M of Sr(AlCl₄)₂+1.25 M SO₂ in thionyl chloride SOCl₂) impregnating a separator consisting of woven glass fiber having a thickness of 150 μm, a height of 45 mm, and a width of 70 mm;
a cylindrical casing 17 made of stainless steel 305 forming the positive pole of the cell and having a thickness of 0.9 mm, an internal diameter of 22.9 mm and a height of 51 mm, forming an envelope around the cathode in direct contact with it via its internal cylindrical surface and having two parallel flat faces forming the two ends of the envelope, wherein the lower planar face 19 forms a single piece with the cylindrical surface, while the upper planar face 21 consists of a piece of glass and metal welded to the cylindrical surface;
the anode, cathode and envelope have the same axis of revolution, the anode is provided on its upper planar face with a cylindrical hole having a diameter of 1.9 mm and a height of 15 mm, wherein the hole is placed in the center of the face, in which is stuck, by one of its ends, a metal rod 23 made of stainless steel 304L (forming the negative pole of the cell) and having a diameter of 2 mm for a length of 40 mm forming a current collector, while the other end of this metal rod is nested in the glass and metal part constituting the upper face of the cylindrical envelope.

The cell not in accordance with the invention has a structure similar to that of the invention, except that the positive electrode consists solely of a carbon matrix consisting of a carbon fiber film having a thickness of 200 μm, a height of 40 mm and a length of 70 mm.

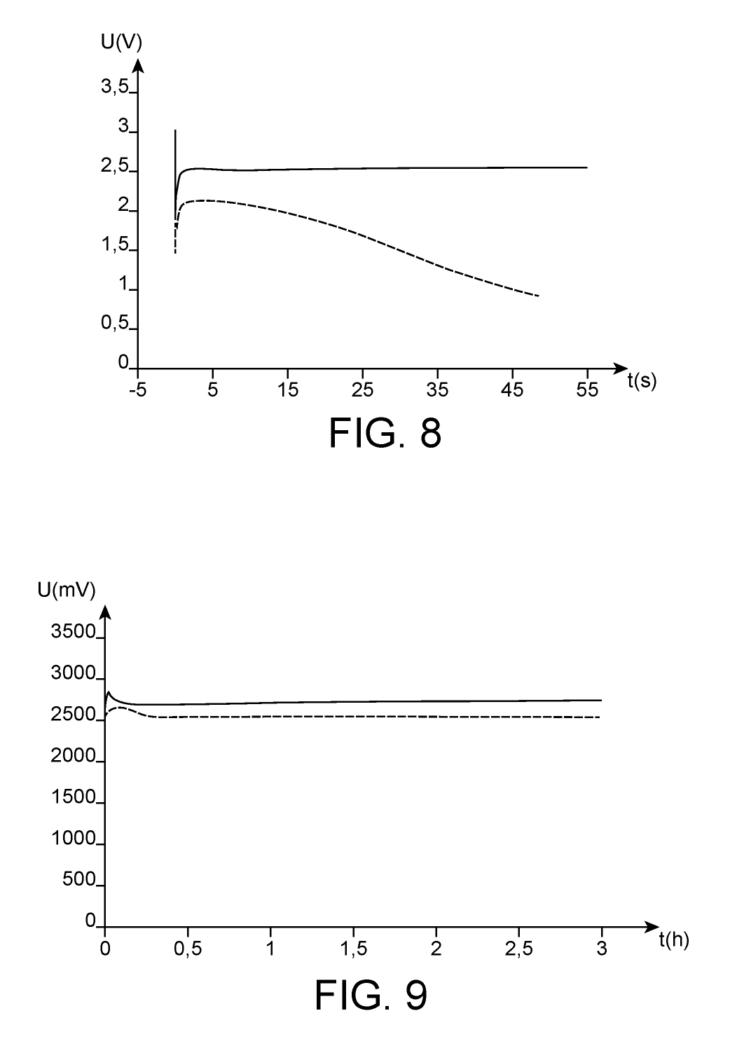

For these two cells, the curve shows the evolution of the cell voltage U (in V) as a function of time (in s) at constant current (20 mA) and at 20° C. (in FIG. 8 respectively a solid line curve for the cell according to the invention and a dashed curve for the cell not according to the invention).

The cell voltage during the first instants of the current draw drops more strongly for the cell not according to the invention than for the cell according to the invention. In addition, the voltage stabilizes over time for the cell according to the invention at a value greater than 2.5 V while falling rapidly for the cell not according to with the invention.

### Example 2

This example is similar to Example 1, except that the experiment is carried out at 20° C. under 10 mA, and wherein the cell not according to the invention comprises a positive electrode comprising an expanded nickel grid of 300 μm thick pasted with a composite material comprising 25% by weight of polyvinylidene fluoride (Teflon®), 37.5% by weight of acetylene black Y50A and 37.5% by weight of YS acetylene black. In this case, the cell using the pasted electrode has the positive electrode connected to the pin (positive pole). The positive electrode has a thickness of 2.6 mm, a height of 30 mm and a width of 40 mm. The electrode is scraped 10 mm over the full height at one end, and a nickel connection 5 mm wide and 45 mm long is welded to the nickel grid and connected to the pin of the glass-to-metal feedthrough.

The curve illustrating the evolution of the cell voltage U (in mV) as a function of time (in h) at constant current (10 mA) and at 20° C. (respectively a solid line curve for the cell not according to the invention and a dashed curve for the cell according to the invention), is shown in FIG. 9.

This figure demonstrates the good behavior of the hybrid positive electrode in the case of a discharge at 20° C. and, in particular, the possibility of being able to perform a few hours of discharge at a voltage greater than 2.5 V under 10 mA at 20° C. These values are close to what is obtained with the cell not according to the invention (with a standard positive electrode acetylene black pasted on a nickel grid).

### Example 3

This example is similar to Example 1 except that the experiment is performed at 10 mA and 220° C.

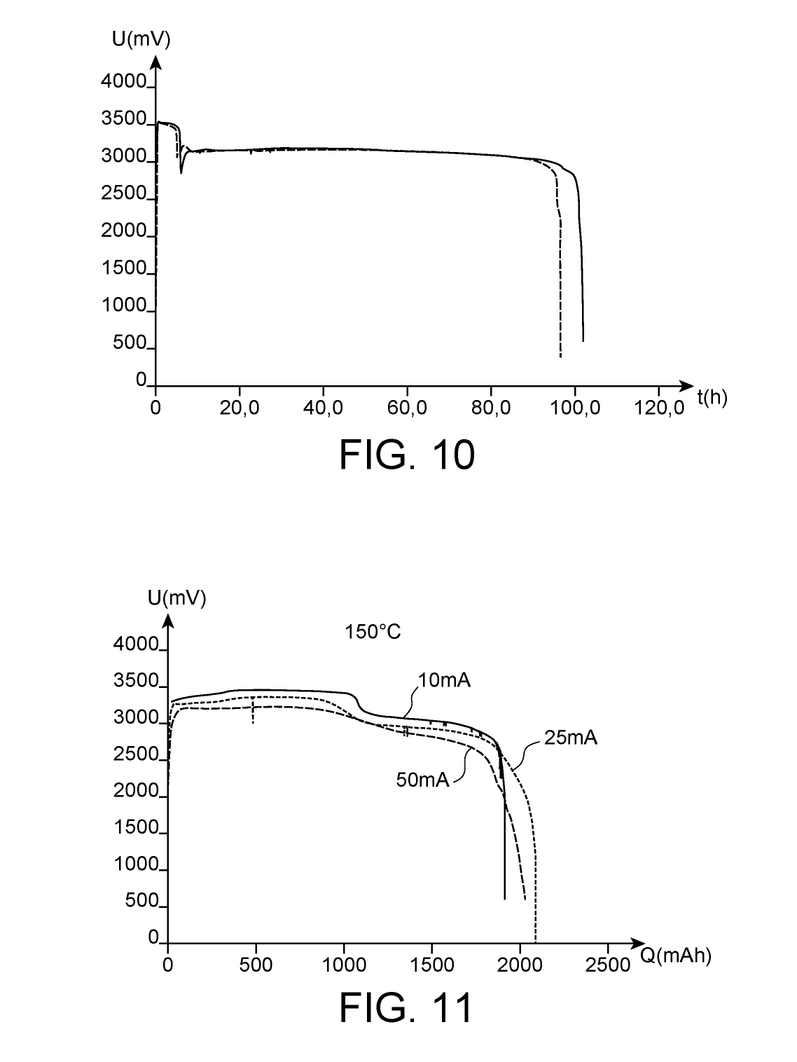

The curve illustrating the evolution of the cell voltage U (in mV) as a function of time (in h) at constant current (10 mA) and at 220° C. (respectively a solid line curve for the cell according to the invention and a dashed curve for the cell not according to the invention), is shown in FIG. 10.

It emerges from this figure that, with respect to a cell comprising a positive electrode consisting solely of a carbon film, the cell according to the invention has properties that are perfectly similar at high temperature, which demonstrates that the hybrid nature of the positive electrode does not negatively affect the properties of the high temperature cell.

### Example 4

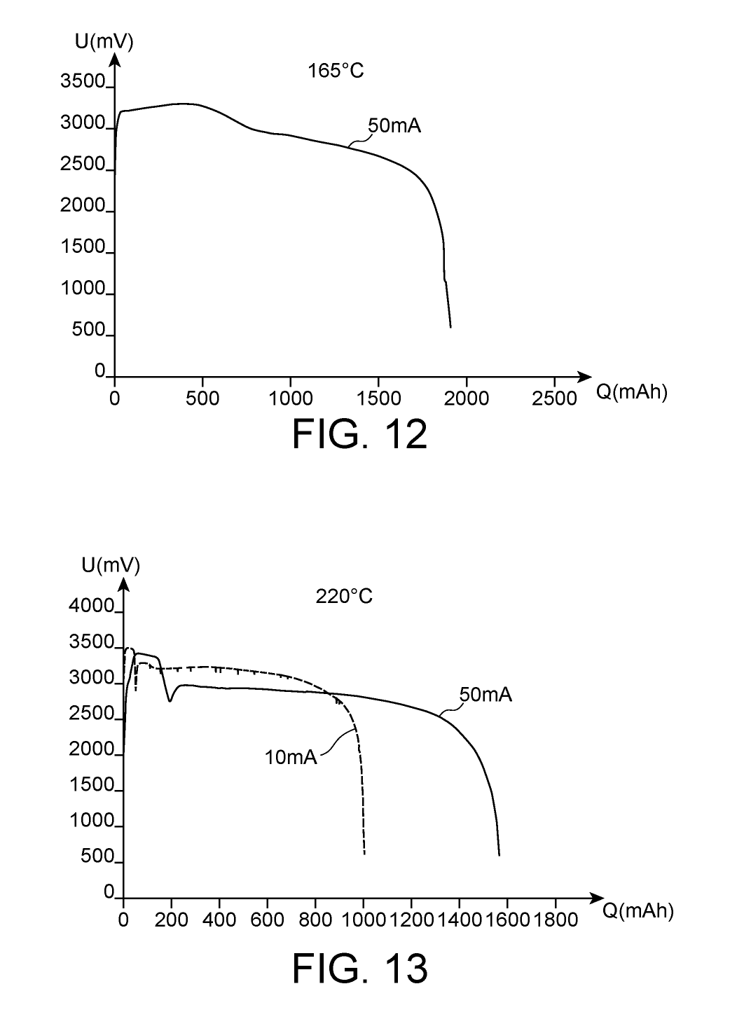

In this example, various discharging experiments are carried out with a cell according to the invention as defined in Example 1:
in a first series of tests at 150° C. at constant currents of 10 mA, 25 mA and 50 mA, wherein the results are shown in FIG. 11, which is a curve illustrating the evolution of the cell voltage U (in mV) as a function of the charge Q (in mAh);
in a second test at 165° C. at a constant current of 50 mA, the results are shown in FIG. 12, which is a curve illustrating the evolution of the cell voltage U (in mV) in load function CL (in mAh);
in a third series of tests at 220° C. at constant currents of 50 mA and 10 mA, wherein the results are shown in FIG. 13, which is a curve illustrating the evolution of the voltage of cell U (in mV) depending on the load Q (in mAh).

It follows from these tests that the cells according to the invention may operate at high temperatures (above 150° C.) and at different speeds while delivering good performance and especially under conditions where lithium could not be used.

What is claimed is:

1. Liquid cathode cell comprising:
a calcium anode;
an electrolyte comprising a sulfur and/or phosphorus oxidizing solvent and at least one salt;
a cathode comprising a compound identical to the aforementioned oxidizing solvent as active material;
characterized in that the cathode comprises a first zone consisting of a carbon matrix comprising entwined carbon fibers having a porosity of at least 90% and a specific surface area of less than or equal to 5 m²/g, and comprising a second zone distinct from the first zone, wherein the second zone consists of a composite material comprising a binder and carbon black.

2. Cell according to claim 1, wherein the carbon matrix is composed predominantly or exclusively of entwined carbon fibers.

3. Cell according to claim 1, wherein the carbon fibers have a length less than 20 mm and a diameter less than 15 μm.

4. Cell according to claim 1, wherein the carbon matrix meets one or more of the following characteristics:
a grammage less than or equal to 20 g/m²;
the matrix is in the form of a plate with a thickness of less than 1 mm, preferably less than 0.5 mm;
the carbon matrix is devoid of polymeric binder.

5. Cell according to claim 1, wherein the carbon matrix is self-supporting.

6. Cell according to claim 1, wherein the carbon matrix is provided with one or more metal parts attached to one of the faces of the matrix by simple welding for the recovery of the current.

7. Cell according to claim 1, wherein the carbon black is acetylene black.

8. Cell according to claim 1, wherein the binder is a polymeric binder belonging to the category of fluorinated ethylenic polymeric binders.

9. Cell according to claim 1 wherein the second zone is deposited on a current collector, which is a strip or a metal gate.

10. Cell according to claim 1, wherein the first zone and the second zone are in contact with each other.

11. Cell according to claim 10, wherein, when the second zone is deposited on a current collector, the contact between the first zone and the second zone is established via the face of the collector of the current on which the second zone is deposited.

12. Cell according to claim 10, wherein the contact between the first zone and the second zone is established by the fact that the composite material constituting the second zone is directly deposited on a portion of the surface of the first zone.

13. Cell according to claim 1, wherein the oxidizing solvent is a sulfur-containing solvent comprising one or more chlorine atoms, a non-chlorinated sulfur solvent or a phosphorus and optionally sulfur-containing solvent comprising one or more chlorine atoms.

14. Cell according to claim 13, wherein the sulfur-containing solvent comprising one or more chlorine atoms is selected from thionyl chloride (SOCl₂), sulfuryl chloride (SO₂Cl₂), disulfur dichloride (S₂Cl₂), and sulfur dichloride (SCl₂).

15. Cell according to claim 13, wherein the phosphorus and optionally sulfur-containing solvent comprising one or more chlorine atoms is selected from phosphoryl trichloride (POCl₃), thiophosphoryl trichloride (PSCl₃).

16. Cell according to claim 1, wherein the oxidizing solvent is thionyl chloride (SOCl₂).
